(19) United States
(12) Patent Application Publication
(10) Pub. No.: US 2012/0061403 A1
(43) Pub. Date: Mar. 15, 2012

(54) Cooking Utensil with V-Shaped or U-Shaped Indentation

(75) Inventor: Jean-Francois BRASSET, Annecy (FR)

(73) Assignee: SEB S A, Ecully (FR)

(21) Appl. No.: 13/178,407

(22) Filed: Jul. 7, 2011

(30) Foreign Application Priority Data
Jul. 9, 2010 (FR) 10 55642

(51) Int. Cl. A47J 27/00

(52) U.S. Cl. 220/573.1

(57) ABSTRACT

The invention relates to a cooking utensil of which the bottom wall comprises an even upper surface and a lower surface (1) comprising concave indentations (2). Each indentation (2) is constituted of two radial branches (3a) and of a central branch (4) connecting the two radial branches (3a).

### INTRODUCTION

This invention relates to a cooking utensil such as a frying pan, a high-sided frying pan, a saucepan or a stewpot, etc.

A cooking utensil is known of the type of which the bottom wall comprises an even upper surface and a lower surface, said lower surface comprising concave indentations.

In the present description indentation (“empreinte” in French language) means a hollow mark or a hollow (blind) impression having a concave shape imprinted by pressure (typically through a shock or successive shocks applied to said lower surface which is typically metallic, at least essentially.

FR 2 667 496 described such a utensil of which the concave indentations are primarily radial grooves. These indentations make it possible to reduce the deformation of the bottom wall.

However, it appears that after a certain period of time, the successive uses for cooking food cause a deformation of the bottom wall which bulges downward, under the effect in particular of the weight.

Another known solution for reducing the deformation of the bottom is to carry out a bottom wall bulging upwards. However, the major disadvantage is that the upper face of the bottom wall is too irregular and the melted fat (oil, butter, etc.) becomes concentrated at the periphery of this wall.

This new disadvantage can be reduced by limiting the initial deformation of the bottom wall upwards. In this case, after a few uses with heat, the bottom wall loses its upward bulged aspeed becomes deformed bulging downwards.

EP 0 970 647 discloses moreover a cooking utensil of which the bottom wall comprises an even upper surface and a lower surface comprising on the contrary a single concave (therefore not passing through) indentation with radial branches constituted (in that they form a whole) of the radial branches 7 all connected together by the continuous circular central branch 4 which as such causes all of the radial branches to communicate between one another.

Such a realisation requires the use of a rather complex indentation matrix and a precise arrangement in relation to the centre of the wall to be marked.

In addition, the indentation is located substantially near/in the vicinity of the centre C of the bottom, this bottom being of course the central portion limited peripherally by the peripheral line P starting from which the bottom rises in order to become the lateral wall. Neither this nor the realisation disclosed in this patent favour the control of the deformation over time.

As for FR 2 919 484, a cooking utensil is disclosed therein of which the bottom wall comprises an even upper surface and a lower surface comprising not one or several empty concave indentations, but indentations at least for some of them partially in the shape of a star with radial branches all connected together, either by a disc or a central shape which can be pierced, or again and relatively in the radial vicinity of the centre of the bottom, via a continuous circular branch.

### BRIEF SUMMARY OF THE INVENTION

This invention aims to realise a cooking utensil improving the resistance to deformation of the bottom wall, immediately and over time, without having a bottom wall bulging upwards too much which would result in a an overly-restricted location of the melted fat.

According to the invention, in the cooking utensil of the aforementioned type, several concave indentations are provided in the bottom and each indentation is constituted (i.e., in accordance with the general meaning of this term: “exclusively comprises”) two radial branches and a central branch connecting the two radial branches. As such, each indentation has (in a front view such as FIGS. 1, 2) the general shape of a U or of a V according to the length of the central branch.

It appears that the use of an indentation in the shape of a U or a V instead of an indentation in the shape of an I makes it possible for the cooking utensil to withstand a higher number of heating and cooling cycles before undergoing deformations, without the flatness of the upper surface of the bottom wall hindering the distribution of the melted fat.

### BRIEF DESCRIPTION OF THE FIGURES

Other particularities and advantages of this invention shall appear in two embodiments given by way of unrestricted examples shown by the annexed drawings wherein:

FIG. 1 is a view of the lower surface of the bottom wall of a frying pan in accordance with a first embodiment; and

FIG. 2 is a view of the lower surface of the bottom wall of a frying pan in accordance with a second embodiment.

FIGS. 3, 4, 5, 6, 7, 8 are cross-sections corresponding respectively to the cross-section lines III-III, IV-IV, V-V, VI-VI, VII-VII, VIII-VIII.

FIG. 9 is shows the results of comparated tests relating to concavity.

### DETAILED DESCRIPTION OF THE INVENTION

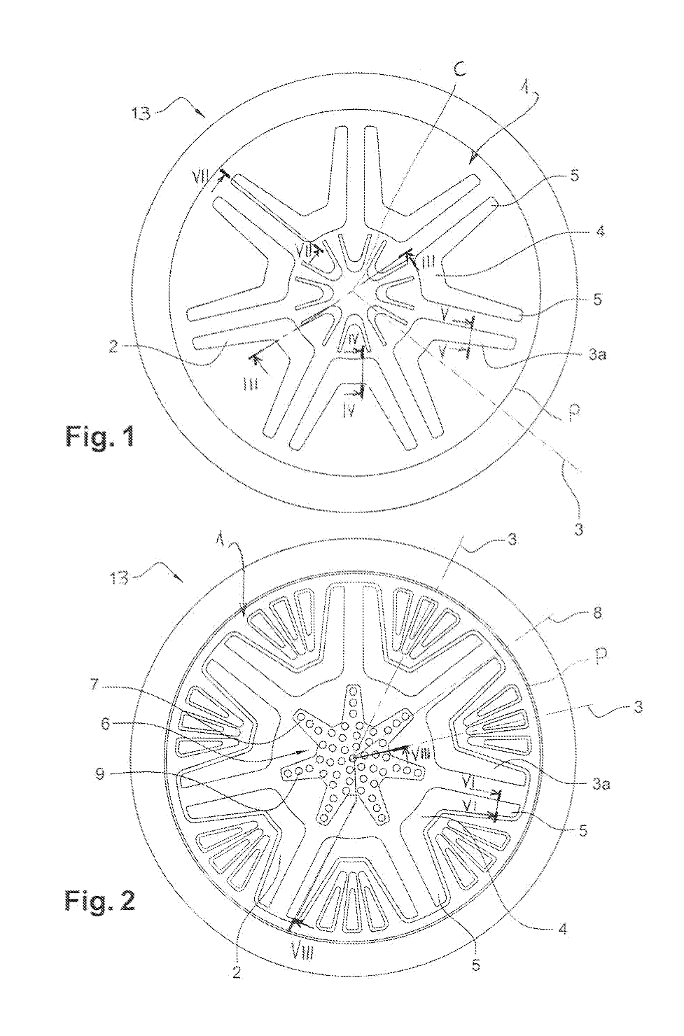

FIGS. 1 and 2 show the lower surface 1 of the bottom wall of a frying pan.

In order to obtain a good distribution of the fat on this wall, the upper surface 10 of the latter is even. As such, it does not have any variations contrary to the lower surface 1; It does not have any holes nor is it hollowed with indentations or other hollows preventing the free sliding of a spatula over this surface 10. It can have small asperities such as those of a PTFE (polytetrafluoroethylene) coating.

As such, the even upper surface 10 shall more preferably be that of an anti-stick layer 11 (such as PTFE) which covers a concave wall in the shape of a cap 12. The surface 10 receives the food items placed in the cooking utensil 13 involved here.

The wall 12 is a priori made of metal. A soft metal, such as aluminium, is recommended.

Contrary to the surface 10, the lower surface 1 of the bottom wall (precisely that of the wall 12) comprises concave indentations 2, each constituted of two radial branches 3a and a central branch 4 connecting the two radial branches 3a. Each indentation 2 therefore comprises only these branches 3a and 4.

The lower surface 1 is that which is placed on the source of heat 15 retained for heating the cooking utensil 13 (gas burner for example).

As has been understood, each indentation 2 is devoid of material; There is no insert 6 inside (see insert 6 hereinafter).

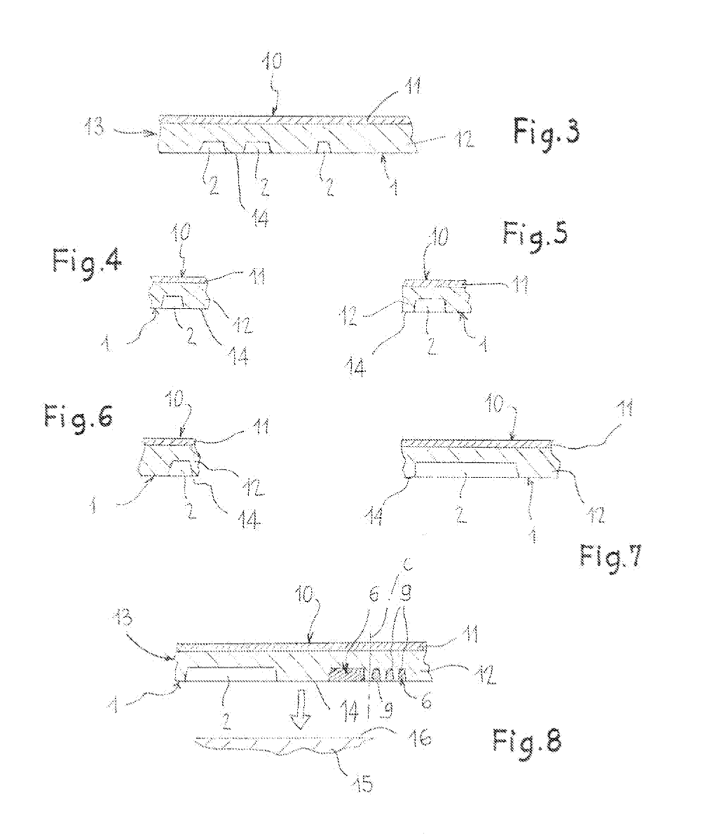

By comparing FIGS. 1-8, there is moreover confirmation that each concave indentation 2 (which is therefore entirely disjointed from the others) is entirely surrounded by a non-hollowed zone 14 of the surface 1 which extends evenly at the same level around each indentation. In a complementary manner, there is also confirmation that this non-hollowed zone 14, which extends peripherally around said indentations 2, generally defines a supporting surface on a planar surface 16, this for the lower surface 1.

Moreover, each indentation has an axis of symmetry 3 passing through the centre of the central branch 4. This axis 3 is directed radially. In this embodiment, the central branch 4, on the one hand, is a branch in an arc of a circle of which the centre is the centre of the bottom wall, and, on the other hand, is directed in the direction of the centre of the bottom wall. The free end 5 of the two radial branches is directed in the direction on the periphery of the bottom wall. As shown in FIGS. 1 and 2, the indentations 2 are, more preferably, arranged at the peripheral portion of the bottom wall.

As such, for the sought stability for the bottom, over time, each indentation 2 here extends radially until closer to the outer peripheral limit P of the bottom than to the centre C of this bottom.

In these embodiments, the length of the central branch 4 is different from that of the free end 5 of each radial branch 3a. More preferably, the central branch 4 is wider than the free ends 5. Also more preferably, the length of the central branch 4 is at most four times that of the free ends 5. An optimum distribution is a simple to double ratio, with a length of the central branch 4 of 10 mm and that of the free ends 5 of 5 mm.

In order to further limit the bending deformations of the bottom wall, it is recommended that the lower surface 1 have an odd number of indentations 2 (at least three) that are evenly distributed in a crown (here, there are seven indentations 2). The number of indentations 2 depends on the diameter of the cooking utensil: three for a bottom diameter less than 100 mm; five for a diameter less than 150 mm; seven for a diameter less than 250 mm; and nine above that are recommended.

More preferably, the bottom wall is made of aluminium, taken from the families 1000, 3000, 4000 or 5000. Its thickness is more preferably between 2 and 5 mm, and the depth of each indentation 2 is between 0.2 and 1 mm. In any case, no indentation passes through the bottom wall.

Having a bottom wall made from 1000, 3000, 4000 or 5000, having a thickness between 2 and 5 mm, in the lower wall wherein are carried out indentations 2 in the shape of a U or of a V makes it possible to substantially limit the deformation of the bottom wall without having to carry out a substantial initial deformation in the opposite direction.

In these embodiments, the indentations are carried out via coining: an aluminium disc (intended to become the bottom wall) is arranged between a punch and a matrix on a press. The cooking utensil is carried out by stamping the disc made of aluminium after punching indentations 2.

In the second embodiment, an insert 6 is fixed to the centre of the lower surface 1 of the bottom wall. The insert 6 has the shape of a star. It is more preferably made of copper or of austenitic stainless steel, and has a thickness between 0.2 and 0.8 mm.

The use of such an insert with indentations (so without an insert, here devoid of material) in the shape of a U or of a V makes it possible to direct the deformation of the bottom wall bulging the latter upwards. The indentations 2 limit the amplitude of the deformation of the bottom wall, and the presence of the insert of which the metal (copper or austenitic stainless steel) is different from that of the bottom wall (aluminium) makes it possible to direct this deformation thanks to the difference of the coefficients of expansion of the two materials.

Each branch 7 defining the star shape of the insert 6 has an axis of symmetry 8 directed radially.

More preferably, the number of branches 7 is equal to the number of indentations 2. In this case, it is preferable that the axes 3 of the indentations 2 form the bisecting lines of the axes 8 of the branches 7, as shown in FIG. 2.

In the second embodiment, the insert 6 is fixed via coining, during the same coining operation of the indentations 2. In order to improve its resistance, the insert 6 comprises attachment orifices 9.

The method for realising a cooking utensil in accordance with this invention can be carried out by following the following steps: coining of the indentations 2 and possibly of the insert 6 on a disc, stamping for the forming of the utensil, application of the various coatings (enamel, non-stick, etc.), and finishing for the utensil.

An alternative is to coat the disc with non-stick coatings (possibly on both faces), then to coin the indentations 2 and possible the insert 6, then to form the utensil by stamping, and finally carrying out the finishing step.

Hereinbelow are the comparative ageing tests carried out according to the internal standards of the applicant that make it possible to compare the resistance of the various frying pans. The measurements of the deformation of the bottom are all carried out after 25 heating cycles at 220° C. and cooling cycles.

With regards to the pre-existing ranges:
with “Essencia” with a smooth inside face (therefore devoid of any indentation, empty or filled), the deformation is 0.09 mm downwards;
with “Evidence” also with a smooth inside face, the deformation is 0.37 mm downwards;
with “Elégance” with an interior face with indentations in the shape of an I (viewed from the front), the deformation is 0.04 mm downwards; and
with “Performance” with an interior face having a copper grill coined at its centre, in accordance with what is provided in FR 2 919 484, the deformation is 0.24 mm upwards.

With regards to the ranges in accordance with this invention:
on a bottom with U-shaped indentations (viewed from the front), without insert, the deformation is 0.09 mm upwards;
on a bottom with U-shaped indentations (viewed from the front), with an insert in the shape of a disc, the deformation is 0.11 mm upwards;
on a bottom with U-shaped indentations (viewed from the front), with a solid insert in the shape of a star, the deformation is 0.14 mm upwards; and
on a bottom with U-shaped indentations (viewed from the front), with an insert punched in the shape of a star, the deformation is 0.13 mm upwards.

As such, in the “Essencia”, “Evidence” and “Elégance” ranges, the bottom wall bulges rapidly downwards (which rapidly renders the frying pan unusable due to its low contact with the heating surface); and in the “Performance” range, the bottom wall bulges upwards too much (which results in a concentration of the fat at the periphery).

On the contrary, in the ranges in accordance with this invention, on the one hand, the bottom wall does not subside, and, on the other hand, the deformation upwards remains low (approximately half less than with the “Performance” range) which makes it possible to have a relatively homogenous distribution of the fat.

This invention is not limited to the two embodiments exposed hereinabove. As such, the U or V-shaped indentations could be evenly distributed in a crown in the form of a series of indentations: the series being evenly distributed in a crown, and each is including several indentations stacked inside one another and having the same axis of symmetry, for example a first indentation arranged in the housing defined by the three branches of a second indentation which itself is arranged in the housing defined by the three branches of a third indentation.

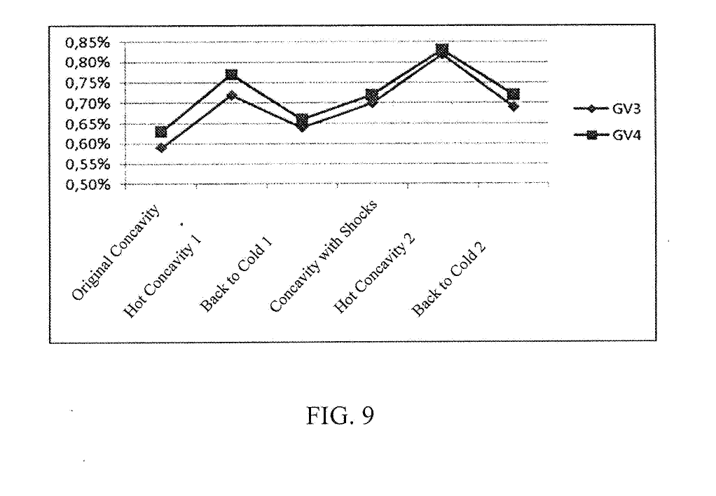

Comparated tests were conducted. They are detailed below and shown in FIG. 9:

| | Articles in | |
|---|---|---|
| Successively | conformity with | Articles |
| conducted | FR-A-2919484 | as claimed |
| Tests | (GV3) | (GV4) |
| Bottom initial | 0.59D % | 0.63D % |
| concavity | | |
| Hot concavity | 0.72D % | 0.77D % |
| 1 (oil poured | | |
| in the bottom | | |
| of the article | | |
| at 180° C.) (a) | | |
| Back to cold | 0.64D % | 0.66D % |
| (t ° down to | | |
| the ambient) | | |
| 1 | | |
| Concavity under | 0.70D % | 0.72D % |
| thermal stresses | | |
| (25 successive | | |
| stresses at about | | |
| 220° C.) (b) | | |
| Hot concavity | 0.82D % | 0.83D % |
| 2 (oil poured | | |
| in the bottom | | |
| of the article | | |
| at 180° C.) | | |
| Back to cold | 0.69D % | 0.72D % |
| (t ° down to | | |
| the ambient) | | |
| 2 | | |
| Gap - Performance | 15% | 7% |
| Time to homogenize | 69 s | 61 s |
| the t ° at the | | |
| bottom (in seconds) | | |
| (c) | | |
| Highest temperature | 262° C. | 246° C. |
| to homogenize the t ° | | |
| at the bottom (in ° C.) | | |
| (c) | | |

D is the reference diameter (at the ambient t °: 23° C.) of the bottom of the article.
(c) Please refer to normalisation EN 12 983-2.

### CONCLUSIONS

Both types of articles have each a bottom showing substantially the same original concavity and the substantially the same hot deformation (after ageing: (b)).

The concavity reached with the GV3 bottoms is, further to said tests, just a little bit lower than those of the tested GV4 bottoms. However, after the first heating and the successive thermal stresses (steps a and b), gap therebetween is reduced.

Mainly, the GV4 bottoms are aging better than the GV3 ones (compared deformation before and after thermal stresses). Further, the reaction of the bottom under thermal elevation (time to homogenize (c) and highest temperature to homogenize the temperature at the bottom) is better with the GV4 articles.

NOTA: Tests as above using a bottom of a culinary article in conformity with EP-A-97064, instead of the above cited GV3 bottom, have provided results not better than those got with a bottom in conformity with FR-A-2919484 as above detailed.

1. A cooking utensil having a bottom wall having an even upper surface and a lower surface, said lower surface comprising concave indentations, wherein each indentation is constituted of two radial branches and of a central branch connecting the two radial branches therebetween.

2. A cooking utensil having a bottom wall having an even upper surface and a lower surface, said lower surface comprising concave indentations without insert or material inside, each indentation includes exclusively two radial branches and a central branch connecting the two radial branches therebetween.

3. The cooking utensil according to claim 1, wherein each indentation is entirely surrounded by a non-hollowed zone of the lower surface which
defines, for said lower surface, a supporting surface on an underlying surface extending in a plane, and/or
extends evenly at the same level around said indentation.

4. The cooking utensil according to claim 1, wherein the central branch is an arc of a circle branch of which the centre is the centre of the bottom wall, and/or the central branch of each indentation is oriented in the direction of the centre of the bottom wall.

5. The cooking utensil according to claim 1, wherein each indentation has an radial axis of symmetry radially passing through the centre of the central branch.

6. The cooking utensil according to claim 1, wherein the length of the central branch is different from that of the free end of the two radial branches, and the of the central branch is longer than the free ends, and is at most four times wider.

7. The cooking according to claim 1, wherein the concave indentations extend until closer to the outer peripheral limit of the bottom than to the centre of this bottom.

8. Cooking utensil according to claim 1, wherein the bottom wall is made of aluminium, and the aluminium belongs to the families 1000, 3000, 4000 or 5000.

9. The cooking utensil according to claim 1, wherein the bottom wall has a thickness between 2 mm and 5 mm.

10. The cooking utensil according to claim 1, wherein each indentation has a depth between 0.2 mm and 1 mm.

11. The cooking utensil according to claim 1, the lower surface comprises an odd number of indentations even distributed in a crown.

12. The cooking utensil according to claim 1, wherein the indentations are arranged at the peripheral portion of the bottom wall.

13. The cooking utensil according to claim 12, wherein an insert is fixed to the center of the lower surface of the bottom wall.

14. The cooking utensil according to claim 13, wherein the insert (6) has the shape of a star.

15. The cooking utensil according to claim 14, wherein the number of branches defining the star shape of the insert is equal to the number of indentations made on the bottom wall.

16. The cooking utensil according to claim 15, wherein the star has a plurality of branches having axes of symmetry forming the bisecting lines of the axes of the indentations.

17. The cooking utensil according to claim 13, wherein the insert (6) has a thickness between 0.2 mm and 0.8 mm.

18. The cooking utensil according to claim 13, wherein the insert is either made of one of copper and austenitic stainless steel.
